(19) United States
(12) Patent Application Publication
(10) Pub. No.: US 2024/0061101 A1
(43) Pub. Date: Feb. 22, 2024

(54) RETRIEVAL METHOD AND APPARATUS FOR RESERVOIR WATER STORAGE

(71) Applicant: TSINGHUA UNIVERSITY, Beijing (CN)

(72) Inventors: DI LONG, Beijing (CN); YI-MING WANG, Beijing (CN); XING-DONG LI, Beijing (CN)

(21) Appl. No.: 18/234,384

(22) Filed: Aug. 16, 2023

(30) Foreign Application Priority Data
Aug. 16, 2022 (CN) 202210980560.2

(51) Int. Cl. G01S 13/90; G01C 13/00; G06V 10/44; G06V 10/764; G06V 10/774; G06V 20/13

(52) U.S. Cl. CPC G01S 13/9021; G01C 13/008; G01S 13/9076; G06V 10/44; G06V 10/764; G06V 10/774; G06V 20/13

(57) ABSTRACT

A retrieval method and a retrieval apparatus for reservoir water storage. The retrieval method includes the following steps. A synthetic aperture radar (SAR) image sequence of a target local waters in a target reservoir is acquired. A water area sequence of the target local waters is determined according to the SAR image sequence. A first relationship between a water level of the target reservoir and a water area of the target local waters of the target reservoir is obtained. The water area sequence is converted into a target water level sequence according to the first relationship. And a water storage sequence of the target reservoir is obtained according to a water level-water storage relationship curve and the target water level sequence.

### CROSS REFERENCE TO RELATED APPLICATION

This application claims priority of Chinese Patent Application No. 202210980560.2, entitled “Retrieval Method and Apparatus for Reservoir Water Storage” and filed on Aug. 16, 2022, which is hereby incorporated in its entirety by reference.

### TECHNICAL FIELD

The present application relates to the technology field of hydrological water resources, and more particularly, to a retrieval method and a retrieval apparatus for reservoir water storage.

### BACKGROUND

A remote sensing retrieval method for a reservoir water storage variation mainly includes a method for computing water storage based on water area and water level of a reservoir, by which the reservoir water storage, after a whole water area or the water level of the reservoir is acquired, is computed with by means of a water level-water storage relationship of the reservoir or a water level-water storage relationship of the reservoir.

Extraction of the water area of the reservoir depends mainly on optical images. The water area extracted from the optical image has high accuracy. However, effective observations cannot be obtained because the optical image is highly susceptible to cloud pollution, therefore a temporal resolution is greatly reduced. Extraction of the water level of the reservoir mainly depends on radar altimetry satellites or laser altimetry satellites. The water level retrieval by the radar altimetry satellite has relatively low accuracy, and the radar altimetry satellite may not be applied to small reservoirs in areas with complex terrain. The water level retrieved by the laser altimetry satellite has high accuracy, but the laser altimetry satellite has a long revisiting period and a low temporal resolution.

### SUMMARY

In view of this, the present application provides a retrieval method for reservoir water storage, a retrieval apparatus for reservoir water storage, a computer device, and a non-transitory computer readable storage medium to improve accuracy of the reservoir water storage retrieval.

In a first aspect, the present application provides the retrieval method for the reservoir water storage, and the method includes the following steps.

A synthetic aperture radar (SAR) image sequence covering target local waters of a target reservoir is acquired.

A water area sequence of the local waters of the target reservoir is determined by using a classification algorithm on a cloud computing platform according to the SAR image sequence. The classification algorithm includes a random forest (RF) algorithm.

An initial water level sequence of the target reservoir is acquired according to at least one of a laser altimetry satellite and a radar altimetry satellite.

An initial partial water area sequence, corresponding to the initial water level sequence, is obtained from the water area sequence according to time information corresponding to the initial water level sequence.

A first relationship between a water level of the target reservoir and a water area of the target local waters of the target reservoir is obtained based on the initial water level sequence of the target reservoir and the initial partial water area sequence of the target reservoir.

The water area sequence is converted into the target water level sequence according to the first relationship.

A water storage sequence of the target reservoir is obtained according to the water level-water storage relationship curve and the target water level sequence.

In an embodiment, the determining the water area sequence of the target local waters by using the classification algorithm on the cloud computing platform according to the SAR image sequence includes the following steps.

The SAR image sequence is classified by the classification algorithm on the cloud computing platform, and determining water pixels in the SAR image sequence according to a classification result, the water pixels being pixels of a water classification.

The water area sequence of the target local waters is determined according to each of the water pixels in the SAR image sequence.

In an embodiment, the obtaining the first relationship between the water level of the target reservoir and the water area of the target local waters of the target reservoir includes the following step.

The initial water level sequence of the target reservoir and the initial partial water area sequence of the target reservoir are processed by a polynomial regression to obtain the first relationship between the water level of the target reservoir and the water area of the target local waters of the target reservoir.

In an embodiment, the retrieval method for the reservoir water storage may further includes the following steps.

A plurality of sample image pairs of the target local waters are acquired, each of the plurality of the sample image pairs includes a sample optical image and a sample SAR image.

A training region boundary is determined according to the sample optical image, and the training region boundary is a boundary between water and land in the target local waters.

Sample features are obtained according to the sample SAR images, and the sample features include a vertical-vertical (VV) backscattering coefficient, a vertical-horizontal (VH) backscattering coefficient, a VV backscattering coefficient processed by a moving average, a VH backscattering coefficient processed by the moving average, an elevation value, and a slope value.

Training samples are selected from the sample SAR images according to the training region boundary, and the sample features of the training samples are inputted into a RF classifier for training to obtain the classification algorithm.

In an embodiment, the training region boundary being determined according to the sample optical image includes the following steps.

Mixed water index (MWI) gray images of the sample optical image are determined.

The MWI gray images are converted into binary images by using a maximum inter-class variance method, and the binary images include pixels representing a water portion and a land portion.

The water portion in the binary images is vectorized to obtain the training region boundary.

In an embodiment, the classifying the SAR image sequence by the classification algorithm on the cloud computing platform, and the determining water pixels in the SAR image sequence according to the classification result includes the following steps.

A feature vector of each of the pixels in the SAR image is obtained according to the SAR image sequence, and the feature vector includes a vertical-vertical (VV) backscattering coefficient, a vertical-horizontal (VH) backscattering coefficient, a VV backscattering coefficient processed by a moving average, a VH backscattering coefficient processed by the moving average, an elevation value, and a slope value.

The feature vector of each of the pixels is inputted into the classification algorithm to obtain a classification result for each of the pixels.

The water pixels in the SAR image sequence are determined according to classification results.

In an embodiment, before the obtaining the water storage volume sequence of the target reservoir according to the water level-water storage volume relationship curve and the target water level sequence, the method further includes the following steps.

Laser point cloud elevation data higher than the highest water level of the target reservoir is acquired from a laser altimetry satellite.

A digital elevation model (DEM) is corrected according to the laser point cloud elevation data.

The elevation value of each grid point in a computation range is obtained from the corrected DEM, and the computation range is obtained according to a maximum water surface range of the target reservoir.

The target water storage corresponding to the target water level is determined according to the target water level, the number of the grid points in the computation range and the elevation value of each of the grid points in the computation range, and the water level-water storage relationship curve of the target reservoir is obtained.

In a second aspect, the present application further provides a retrieval apparatus for the reservoir water storage, and the apparatus includes an image acquisition module, an area computation module, a relationship computation module, a water level computation module and a water storage computation module.

The image acquisition module is configured to acquire a synthetic aperture radar (SAR) image sequence of a target local waters in a target reservoir.

The area computation module is configured to determine a water area sequence of the target local waters by using a classification algorithm on a cloud computing platform according to the SAR image sequence, and the classification algorithm includes a random forest (RF) algorithm.

The relationship computation module is configured to acquire an initial water level sequence of the target reservoir according to at least one of a laser altimetry satellite and a radar altimetry satellite, obtain an initial partial water area sequence, corresponding to the initial water level sequence, from the water area sequence according to time information corresponding to the initial water level sequence, and obtain a first relationship between a water level of the target reservoir and a water area of local waters of the target reservoir based on the initial water level sequence of the target reservoir and the initial partial water area sequence of the target reservoir.

The water level computation module is configured to convert the water area sequence into a target water level sequence according to the first relationship.

The water storage computation module is configured to obtain the water storage sequence of the target reservoir according to the water level-water storage relationship curve and the target water level sequence.

In an embodiment, the area computation module is further configured to classify the SAR image sequence by the classification algorithm on the cloud computing platform, and determine water pixels in the SAR image sequence according to a classification result, where the water pixels are pixels of a water classification, and the area computation module is further configured to determine the water area sequence of the target local waters according to each of the water pixels in the SAR image sequence.

In an embodiment, the relationship computation module, is further configured to process the initial water level sequence of the target reservoir and the initial partial water area sequence of the target reservoir by a polynomial regression to obtain the first relationship between the water level of the target reservoir and the water area of the target local waters of the target reservoir.

In an embodiment, the retrieval apparatus for the reservoir water storage further includes an algorithm training module configured to acquire a plurality of sample image pairs of the target local waters, where each of the plurality of the sample image pairs includes a sample optical image and a sample SAR image. The algorithm training module is configured to determine a training region boundary according to the sample optical image, where the training region boundary is a boundary between water and land in the target local waters. The algorithm training module is configured to obtain sample features according to the sample SAR images, where the sample features include a vertical-vertical (VV) backscattering coefficient, a vertical-horizontal (VH) backscattering coefficient, a VV backscattering coefficient processed by a moving average, a VH backscattering coefficient processed by the moving average, an elevation value, and a gradient value. And the algorithm training module is configured to select training samples from the sample SAR images according to the training region boundary, and input the sample features of the training samples into a RF classifier for training to obtain the classification algorithm.

In an embodiment, the algorithm training module is further configured to determine mixed water index (MWI) gray images of the sample optical image, and convert the MWI gray images into binary images by using a maximum inter-class variance method, where the binary images include pixels representing a water portion and a land portion, and vectorize the water portion in the binary images to obtain the training region boundary.

In an embodiment, the area computation module, is further configured to obtain a feature vector of each of the pixels in the SAR image according to the SAR image sequence, and the feature vector including a vertical-vertical (VV) backscattering coefficient, a vertical-horizontal (VH) backscattering coefficient, a VV backscattering coefficient processed by a moving average, a VH backscattering coefficient processed by the moving average, an elevation value, and a slope value, and is further configured to input the feature vector of each of the pixels into the classification algorithm to obtain a classification result of the each of the pixels, and determine the water pixels in the SAR image sequence according to classification results.

In an embodiment, the retrieval apparatus for the reservoir water storage further includes a curve acquisition module. The curve acquisition module is configured to acquire laser point cloud elevation data higher than the highest water level in the target reservoir from the laser altimetry satellite, and configured to correct the digital elevation model (DEM) according to the laser point cloud elevation data, and which is configured to obtain the elevation value of each grid point in the computation range, from the corrected DEM. The computation range is obtained according to the maximum water surface range of the target reservoir. The curve acquisition module is configured to determine the target water storage corresponding to the target water level according to the target water level, the number of the grid points in the computation range, and the elevation value of each of the grid points in the computation range, and configured to obtain the water level-water storage relationship curve of the target reservoir.

In a third aspect, the present application further provides a computer device including a memory and a processor. The memory has a computer program stored thereon. The processor, when executing the computer program, implements the steps in the above method embodiments.

In a fourth aspect, the present application further provides a non-transitory computer-readable storage medium, having a computer program stored thereon. The computer program, when executed by a processor, causes the processor to implement the steps in the above method embodiments.

In the retrieval method and the apparatus for the reservoir water storage, the computer device, and the non-transitory computer-readable storage medium above, the SAR image sequence of the target local waters of the target reservoir is acquired, the water area sequence of the target local waters is determined according to the SAR image sequence, the first relationship between the water level and the water area of the target local waters of the target reservoir is obtained, the water area sequence is converted into the target water level sequence according to the first relationship, and the water storage sequence of the target reservoir is obtained according to the water level-water storage relationship curve and the target water level sequence. In the conventional method, which is based on the whole water area of the reservoir extracted from the optical images and the water level inversed from the laser altimetry satellite, the water storage of the reservoir is computed by means of the water level-water storage relationship of the reservoir or the water area-water storage relationship of the reservoir, which requires a large amount of computation, increases the computational cost and introduces more uncertainties, and the computed result has a low temporal resolution and a low computational accuracy. Compared with the method of extracting the whole reservoir area in the related art, the method of the present application includes obtaining the water area sequence of the target local waters, and the amount of data is comparatively small, thus reducing computational load, simplifying the computation, and reducing computational resource consumption and computation errors. In addition, the SAR images are acquired from the Sentinel-1 satellite, and have a comparatively high temporal resolution, thus the temporal resolution of the target water level sequence of the present application finally obtained by converting is high, thereby improving the accuracy of the retrieval result of the water storage.

### BRIEF DESCRIPTION OF THE DRAWINGS

FIG. 1 is a schematic flow chart of a retrieval method for reservoir water storage in accordance with an embodiment.

FIG. 2 is a schematic flow chart of step 104 in accordance with an embodiment.

FIG. 3 is a schematic flow chart of step 106 in accordance with an embodiment.

FIG. 4 is a schematic flow chart of the retrieval method for reservoir water storage in accordance with another embodiment.

FIG. 5 is a schematic flow chart of step 404 in accordance with an embodiment.

FIG. 6 is a schematic flow chart of step 202 in accordance with an embodiment.

FIG. 7 is a schematic flow chart of a retrieval method for reservoir water storage in accordance with yet another embodiment.

FIG. 8 is a flow chart of a remote sensing retrieval algorithm for reservoir water storage in accordance with yet another embodiment.

FIG. 9 is a schematic image of the Xiaowan Reservoir in accordance with an embodiment.

FIG. 10 is a schematic diagram illustrating a relationship between water storage sequence of the Xiaowan Reservoir by multi-source remote sensing retrieval and dead storage and total storage in accordance with an embodiment.

FIG. 11 is a schematic diagram illustrating a comparison between multi-source remote sensing retrieval values of the water level of the reservoir and measured values thereof in accordance with an embodiment.

FIG. 12 is a block diagram illustrating a structure of a retrieval apparatus for reservoir water storage in accordance with an embodiment.

FIG. 13 is a schematic view illustrating an internal configuration structure of a computer device in accordance with an embodiment.

### DETAILED DESCRIPTION OF THE EMBODIMENTS

In order to make objectives, technical solutions, and advantages of the present application clearer and more understandable, the present application will be further described with reference to the accompanying drawings and embodiments. It should be understood that the specific embodiments described herein are used to explain the disclosure only rather than limit the disclosure.

In technical fields of optical remote sensing, radar remote sensing, altimetry, geographic information system, and hydrology and water resources, etc., reservoirs play a vital role in storing surface water resources. Over the past few decades, a large number of reservoirs and dams have been built worldwide for flood control, power generation, and irrigation. The reservoirs will have a significant effect on the runoff of a basin and affect the spatial and temporal distribution of the surface water resources. Models and satellite altimetry data show that seasonal changes in reservoir water storage account for more than half of the surface water resources change. In some hydrological models, the effect of the reservoirs on the river runoff is considered, and generally the operating process of the reservoir is simulated by using a conceptual model, which, however, may differ from an actual situation. Accurately monitoring information on the reservoir water level and the reservoir water storage assists in realizing the role of the reservoir in runoff regulation and water resources management. However, monitored in situ data of the reservoir water level and the reservoir water storage are quite limited, or difficult to obtain due to information confidentiality, so it is an effective method to obtain the reservoir water storage change by satellite remote sensing.

A remote sensing retrieval method for the reservoir water storage change mainly includes a method based on the water area and the reservoir water level, in which the whole reservoir water area or reservoir water level is acquired, and the reservoir water storage is computed based on a water level-water storage relationship of the reservoir, or a water area-water storage relationship of the reservoir. The extraction of the reservoir water area depends mainly on an optical image or an SAR (Synthetic Aperture Radar) image. The water surface area extracted from the optical image has high accuracy. However, effective observations cannot be obtained because the optical image is highly susceptible to cloud pollution, thus greatly reducing the temporal resolution. The extraction of the reservoir water level mainly depends on a radar altimetry satellite or a laser altimetry satellite. The water level inversed by the radar altimetry satellite has a relatively low accuracy, and the radar altimetry satellite may not be applied to the small reservoirs in areas with complex terrain. The water level inversed by the laser altimetry satellite has a relatively high accuracy, but the laser altimetry satellite has a long revisiting period and has a relatively low temporal resolution. Therefore, the current method for computing the reservoir water storage has defects of lack of universality, harsh implementation conditions, and low accuracy of computation results.

Therefore, the inventors have invented a method combining altimetry satellite data with an extraction of the reservoir water area based on the SAR image which is not affected by clouds, and the method can better obtain a reservoir water storage sequence with a high accuracy and a high temporal resolution. The retrieval method for the reservoir water storage provided in the present application is based on this theory. Key problems to be solved by the retrieval method for the reservoir water storage include: firstly, how to accurately identify a water surface range in the SAR image, and secondly, how to correct a digital elevation model (DEM) by using the altimetry satellite data to obtain a water level-reservoir storage curve with a high accuracy.

At present, other retrieval algorithms for the water storage have many disadvantages. For example, when the reservoir water area is extracted from the SAR image, an accurate water range is difficult to be obtained due to the SAR image with much noise and easily affected by a terrain. What's more, a large amount of computation is required to extract a whole reservoir water surface area directly from the SAR image, which increases computational costs and introduces more uncertainties.

Based on this, an embodiment of the present application provides a retrieval method for reservoir water storage to solve the above problems, and to overcome the defects, such as lack of universality, harsh implementation conditions, and low accuracy of computation results, etc., of the method for computing the reservoir water storage in the related art, thereby realizing a remote sensing monitoring for the reservoir water storage at a low cost, in a large range, and with a high efficiency.

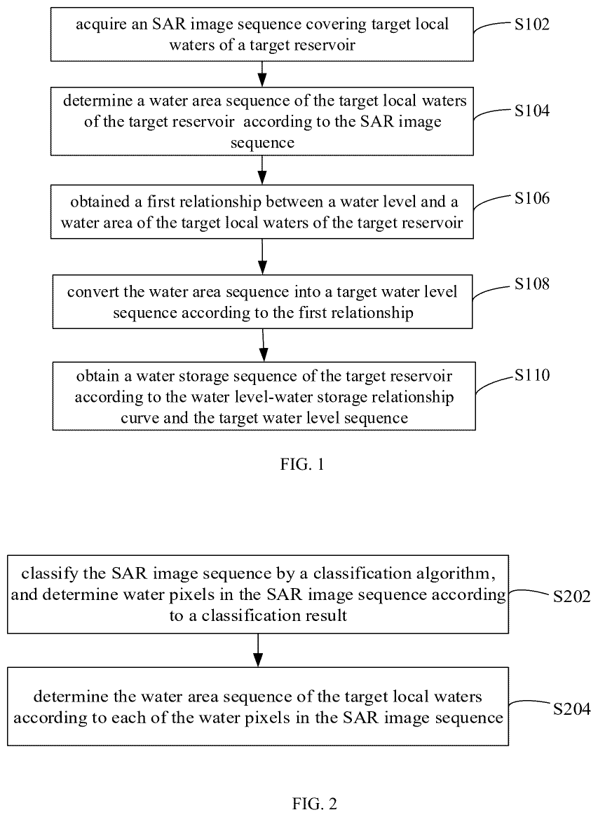

In an embodiment, as shown in FIG. 1, the retrieval method for reservoir water storage is provided. This embodiment is illustrated by taking the method applied to a server as an example. It should be understood that the method may be applied to a terminal, or applied to a system including a terminal and a server and be implemented by an interaction between the terminal and the server. In this embodiment, the method includes the following steps 102 to 110.

In step 102, an SAR image sequence covering target local waters of a target reservoir is acquired.

In an embodiment of the present application, the target reservoir is a reservoir whose water storage is to be retrieved, and the target local waters are local waters properly selected within a water surface area extraction range for the target reservoir. In one of the embodiments, the target local waters refer to a region of the target reservoir with a flat terrain and wide open water surface, in order to improve the accuracy of a boundary extraction of the target local waters and ensure the accuracy of further processing results. The SAR image sequence includes a plurality of SAR images which change with time. After the target local waters are determined, the plurality of SAR images including the target local waters may constitute the SAR image sequence.

For example, when the target reservoir is a relatively narrow and long reservoir such as the Xiaowan reservoir, a comparatively wide region of the Xiaowan reservoir, which is selected from an open data set, e.g., Joint Research Centre Global Surface Water (JRC GSW), or Global Reservoir and Dam (GRanD), together with a buffer zone, serve as a Region Of Interest (ROI) of the local waters area. If a vector boundary of the target reservoir is included in the GRanD data set, the vector boundary of the target reservoir may be directly downloaded from the GRanD data set. If the vector boundary of the target reservoir is not included in the GRanD data set, a historical maximum water surface range of the target reservoir in the JRC GSW data may be downloaded, and a grid file of the historical maximum water surface range is vectored by the Geographic Information System (GIS) or Geo-Information system software to serve as the vector boundary of the target reservoir. The vector boundary is a vector file of the water surface range of the reservoir, which has a common file format of .shp. The SAR images may be acquired from the Sentinel-1 satellite.

In step 104, a water area sequence of the target local waters of the target reservoir is determined according to the SAR image sequence.

In an embodiment of the present application, the water area sequence includes water areas of the target local waters of the target reservoir in the plurality of SAR images changing with time. The water area sequence may be obtained according to the water areas of the target local waters of the target reservoir in the plurality of SAR images which change with time in the SAR image sequence.

In step 106, a first relationship between a water level and a water area of the target local waters of the target reservoir are obtained.

In an embodiment of the present application, the first relationship may represent a relationship between the water level of the target reservoir and the water area of the target local waters when the target reservoir is at this water level. The first relationship between the water level of the target reservoir and the water area of the target local waters of the target reservoir may be determined by obtaining the water levels of the target reservoir of some days and the water areas of the target local waters of the target local waters of the same days.

In step 108, the water area sequence is converted into a target water level sequence according to the first relationship.

In an embodiment of the present application, the target water level sequence includes a plurality of water levels changing with time of the target reservoir. The water area sequence may be substituted into the first relationship to convert the water areas in the water area sequence into the water levels according to the first relationship, therefore the water area sequence is converted into a target water level sequence. The temporal resolution of the target water level sequence is the same as that of the water area sequence.

In step 110, a water storage sequence of the target reservoir is obtained according to a water level-water storage relationship curve and the target water level sequence.

In an embodiment of the present application, the water level-water storage relationship curve is a relationship curve between the water level and the water storage corresponding to the water level in the target reservoir. The water level-water storage relationship curve can be computed by the DEM. By substituting the target water level sequence into a relation formula representing the water level-water storage relationship curve, the water storage sequence of the target reservoir may be obtained, and therefore a retrieval result of the water storage of the target reservoir is achieved.

In the retrieval method for the reservoir water storage, the SAR image sequence of the target local waters of the target reservoir is acquired, the water area sequence of the target local waters is determined according to the SAR image sequence, the first relationship between the water level and the water area of the target local waters of the target reservoir is obtained, the water area sequence is converted into the target water level sequence according to the first relationship, and the water storage sequence of the target reservoir is obtained according to the water level-water storage relationship curve and the target water level sequence. Compared with the method of extracting the whole reservoir area in the related art, the method of the present application includes obtaining the water area sequence of the target local waters, and the amount of data is comparatively small, thus reducing computational load, simplifying the computation, and reducing computational resource consumption and computation errors. In addition, the SAR images are acquired from the Sentinel-1 satellite, and have a comparatively high temporal resolution, thus the temporal resolution of the target water level sequence of the present application finally obtained by converting is high, thereby improving the temporal resolution of the retrieval result of the water storage.

In an embodiment, as shown in FIG. 2, the step 104 of determining the water area sequence of the target local waters according to the SAR image sequence may include the following steps 202 and 204.

In step 202, the SAR image sequence is classified by a classification algorithm, and water pixels in the SAR image sequence are determined according to a classification result, where the water pixels are pixels of water classification.

In an embodiment of the present application, the classification algorithm is a Random Forest (RF) algorithm. For each of the SAR images in the SAR image sequence, water classification may be obtained by the classification algorithm. And pixels in the SAR image may be classified into two classifications, namely the water or the land. The classification result may be used to characterize whether a pixel is water. The water pixels are pixels of water classification.

In step 204, the water area sequence of the target local waters is determined according to each of the water pixels in the SAR image sequence.

In an embodiment of the present application, the water area sequence includes the water areas of the target local waters of the target reservoir in the plurality of SAR images changing with time. After the water pixels of each of the SAR images in the SAR image sequence are determined, the water area of each of the SAR images may be computed according to the number of the water pixels and the resolution of the SAR image, thus obtaining the water area sequence of the target local waters.

Each of the SAR images is acquired from the Sentinel-1 satellite, therefore, the temporal resolution of the water area sequence is determined by the revisiting period of the Sentinel-1. The Sentinel-1 consists of two identical satellites and has an irregular revisiting period, which is about 7 days. The temporal resolution of the water area sequence of the target local waters is 7 days. The above processes of classifying the SAR image sequence by the classification algorithm and determining the water area sequence of the target local waters are performed on the Google Earth Engine (GEE) cloud computing platform, so that local computational load can be greatly reduced.

Compared with the retrieval method based on the whole water area of the reservoir in the related art, in the embodiment of the present disclosure, the water area sequence of the target local waters may be obtained by classifying the SAR image sequence, thereby reducing the computation errors of the water storage and the computational resource consumption, and significantly improving the spatiotemporal resolutions and the accuracy of the retrieval of the reservoir water storage.

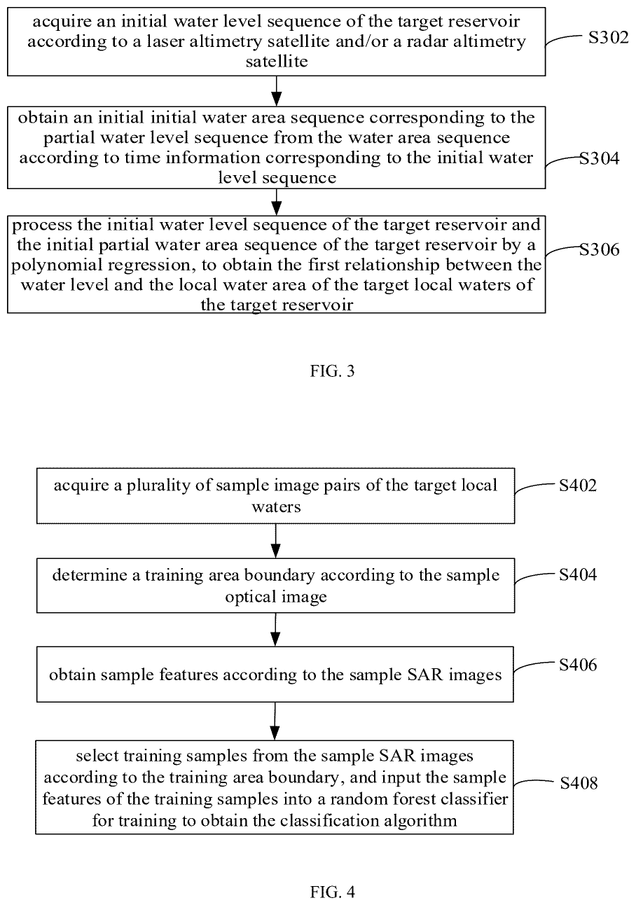

In an embodiment, as shown in FIG. 3, the step 106 of obtaining the first relationship between the water level and the water area of the target local waters of the target reservoir may include the following steps 302 to 306.

In step 302, an initial water level sequence of the target reservoir is acquired according to the laser altimetry satellite and/or the radar altimetry satellite.

In an embodiment of the present application, the initial water level sequence includes the water levels changing with time of the target reservoir acquired according to the satellite altimetry data. For the laser altimetry satellite ICESat-2, the water levels of the target reservoir may be directly extracted from the inland water surface height (ATL 13) data set. For the acquired water levels of the target reservoir of the same day, outliers beyond three times the standard deviation are excluded, and a median of the remaining water levels is regarded as the water level of the day, thereby obtaining the initial water level sequence. If the number of the data of the target reservoir in the ICESat-2 is small, the radar altimetry satellite data may be supplemented. Taking the Jason-3 satellite as an example, the waveform data of the Jason-3 satellite are retracked by a threshold method, and other corrections are performed to retrieve the water level of the target reservoir. The water levels of the same day are selected in the same way above and supplemented to the data of the water levels obtained from the ICESat-2, to form the initial water level sequence.

In step 304, an initial partial water area sequence corresponding to the initial water level sequence is obtained from the water area sequence according to time information corresponding to the initial water level sequence.

After the initial water level sequence is obtained, the water areas of corresponding times may be selected from the water area sequence according to the time information contained in the initial water level sequence, to form the initial partial water area sequence. The temporal resolution of the initial partial water area sequence is the same as that of the initial water level sequence. The revisiting period of the laser altimetry satellite is long, the temporal resolution of the retrieved initial water levels is low, and the temporal resolution of the water area sequence is high. The water areas corresponding to the same time as the initial water levels in the initial water level sequence may be obtained from the water area sequence, to form the initial partial water area sequence corresponding to the initial water level sequence.

In step 306, the initial water level sequence of the target reservoir and the initial partial water area sequence of the target reservoir are processed by a polynomial regression to obtain the first relationship between the water level of the target reservoir and the water area of the target local waters of the target reservoir.

The first relationship between the water level and the water area of the target local waters of the target reservoir is used to represent a corresponding relationship between the water level and the water area at the same time. The embodiment of the present application does not limit a specific computation method of the polynomial regression, as long as the first relationship between the water level and the water area can be obtained.

According to the embodiment of the present disclosure, the first relationship of the water level-water area is constructed by combining the initial water level sequence of the target reservoir with the water area sequence of the target reservoir, thereby facilitating converting the water area sequence into the target water level sequence, improving the temporal resolution of the water level sequence, and improving the temporal resolution of the water storage sequence during the retrieval of the water storage.

In an embodiment, as shown in FIG. 4, the retrieval method for the reservoir water storage may further include the following steps.

In step 402, a plurality of sample image pairs of the target local waters are acquired, and each of the sample image pairs includes a sample optical image and a sample SAR image.

The sample optical images may be acquired from the Sentinel-2 satellite, and the sample SAR images may be acquired from the Sentinel-1 satellite. After the target local waters is determined, twelve sample image pairs of close time points, when the satellites pass through the target local waters, may be selected. For example, the time interval between time points, when the sample optical image and the sample SAR image in each of the sample image pairs are collected respectively, is within 5 days. The twelve sample image pairs cover time points when the water area of the target local waters is maximum or minimum as much as possible, thus increasing the number of samples for training and testing the classification algorithm, and improving the robustness of the classification algorithm.

In step 404, a training region boundary is determined according to the sample optical images, wherein the training region boundary is a boundary between water and land in the target local waters.

The accuracy of the water area extracted from the optical images is high, but the effective observations cannot be obtained because the optical images are highly susceptible to cloud pollution. Therefore, the sample optical images may be selected to obtain the sample optical images each with a high ratio of effective observation pixels before the training region boundary is determined. The effective observation pixels are pixels that are not covered by the clouds. For example, the sample optical images in which the cloud coverage in the target local waters is less than 20% may be selected. The sample SAR images acquired by the Sentinel-1 are not affected by the clouds, and may completely cover the target local waters. The training region boundary is determined by using the selected sample optical images, and the training region boundary is a boundary between the water and the land in the target local waters, that is, a boundary of the water surface. The training region boundary may be input into the Google Earth Engine (GEE) cloud computing platform for training the classification algorithm. Since a spatial resolution in the corresponding band of the Sentinel-2 satellite is at a range from 10 m to 20 m, a spatial resolution of the training region boundary determined by using the sample optical images is relatively high.

In step 406, sample features are obtained according to the sample SAR images, and the sample features include a vertical-vertical backscattering coefficient, a vertical-horizontal backscattering coefficient, a vertical-vertical backscattering coefficient processed by a moving average, a vertical-horizontal backscattering coefficient processed by a moving average, an elevation value and a slope value.

The sample features are used to be inputted into a random forest (RF) classifier for training to obtain a classification algorithm. The resolution of the sample SAR image acquired by the Sentinel-1 satellite is 10 m, and the sample SAR image contain backscattering coefficients of the water surface and the land in the target local waters at a vertical-vertical (VV) polarization channel and at a vertical-horizontal (VH) polarization channel. The Sentinel-1 SAR satellite transmits a polarized radar wave, and performs a polarization once more when receiving an incoming wave. For example, VV represents vertical-vertical polarization, i.e., the vertical polarizations are used for both transmitting and receiving, and VH represents vertical-horizontal polarization, i.e., the vertical polarization and the horizontal polarization are respectively used for transmitting and receiving. Each of the pixels in the sample SAR image has a vertical-vertical (VV) backscattering coefficient, and a vertical-horizontal (VH) backscattering coefficient. Since the backscattering coefficient of the water surface tends to be lower than that of the land, the classification for pixels of water and land can be realized.

However, the sample SAR images are easily affected by the terrain, and therefore it is necessary to perform a terrain correction on the sample SAR images to eliminate foreshortening, overlay and shadows, which are generated by the terrain, to some extent. The processing method in the related art is to perform a low-pass filtering on the SAR images. In the embodiments of the present disclosure, the VV and VH backscattering coefficients which are processed by the 5×5 moving average, and a DEM with a resolution of 30 m, namely the NASADEM of National Aeronautics and Space Administration (NASA), are directly introduced to eliminate the effect of the terrain on the sample SAR images. The 5×5 moving average means that a 5×5 square window composed of a current pixel and 24 pixels around the current pixel is used as a moving average window, and a mean value of the backscattering coefficients of the pixels in the window is assigned to the central pixel, thereby reducing high-frequency noise. The resolution of the vertical height of the NASADEM is 1 m, which may reflect a terrain change in the reservoir. After the NASADEM is processed, a distribution of slope in the terrain of the reservoir area may be obtained. The elevation value and the slope value of each of the pixels may be obtained from the NASADEM, and the elevation value and the slope value of each of the pixels, together with the VV backscattering coefficient, the VH backscattering coefficient, the VV backscattering coefficient processed by the moving average, and the VH backscattering coefficient processed by the sliding average, constitute the sample features.

In step 408, training samples are selected from the sample SAR images according to the training region boundary, and the sample features of the training samples are inputted into the RF classifier for training to obtain the classification algorithm.

The training samples are pixels randomly selected within the water surface range and beyond the water surface in the sample SAR images according to the training region boundary. After the training region boundary of the target local waters is determined, a buffer zone is processed for the training region boundary to ensure that a ratio of the water surface area to the non-water surface area in a region, where the training samples are selected as 1:3 of water and non-water. The buffer processing is extending the training region boundary outwards by a certain distance, so as to prevent the water surface of the target local waters at some time points from extending beyond the water surface range previously confirmed to cause a deviation of the extraction result of the area of the waters. The ratio of the number of the water pixels to the number of the land pixels in the selected training samples is 1:3. For example, 5000 pixels within the water surface range and 15000 pixels out of the water surface range are respectively selected as the training samples, and by using the sample features of these pixels as independent variables and as a training set of the RF classifier, and using types of the pixels corresponding to the sample features as labeling information, the RF classifier is trained to obtain the classification algorithm. The RF classifier may consist of 50 decision trees.

Exemplarily, after 12 sets of training samples are selected from 12 sets of sample SAR images, the RF classifier is trained by using a 12-fold test method to obtain the classification algorithm. The 12-fold (k-fold, where k=12) test method is a conventional test method of a machine learning algorithm. Each time 11 sets of training samples are selected for training, and the remaining one set of training samples is used for testing the classification algorithm. This process is repeated 12 times, and twelve independent accuracy results are obtained and combined to evaluate the accuracy of the classification algorithm.

In an embodiment of the present application, the training process and the testing process of the classification algorithm may be performed on the GEE, thus effectively processing image data in massive databases online, saving local storage and operation space, improving efficiency, and reducing costs. The training region boundary is determined by the sample optical images, then the training samples are selected from the sample SAR images according to the training region boundary, and the classification algorithm is obtained by six sample features of the training samples, therefore eliminating the effect of the terrain on the SAR images, and improving the accuracy of the classification algorithm.

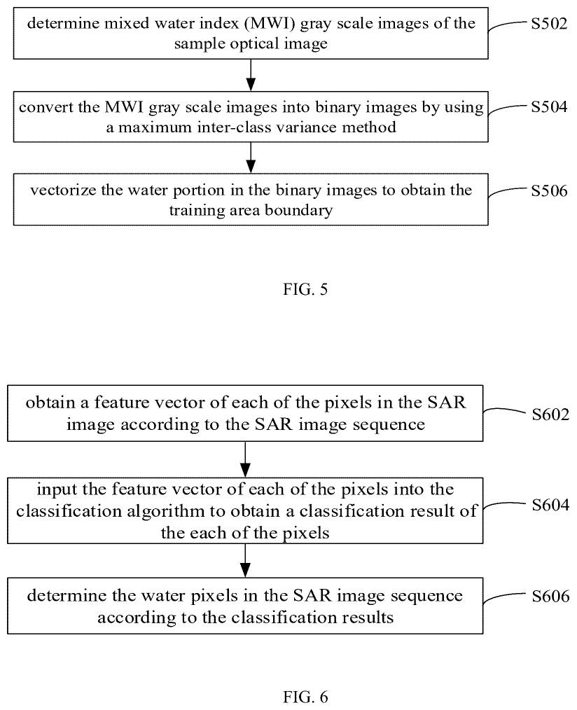

In an embodiment, as shown in FIG. 5, the step 404 of determining the training region boundary according to the sample optical images may include the following steps 502 to 506.

In step 502, mixed water index (MWI) gray images of the sample optical images are determined.

In an embodiment of the present application, data of a plurality of spectral bands are converted into data of one band by using the MWI, therefore the distribution of the MWI is a gray image rather than a common color satellite image. After the sample optical images are selected, and the sample optical images having effective observation pixels of a high ratio are obtained, the MWI of the sample optical images satisfies the following formulas (1), (2), and (3).

$$M W I = max \{ NDMI , {AWEI}_{s h} \} \qquad ( 1 )$$

$$NDMI = \frac{{RE}_{3} - R {E}_{4}}{R {E}_{3} + R {E}_{4}} \qquad ( 2 )$$

$$AWE {I}_{s h} = Blue + 2.5 Green - 1.5 ( NIR + {SWIR}_{1} ) - 0.25 {SWIR}_{2} \qquad ( 3 )$$

Where, RE₃, RE₄, Blue, Green, NIR, SWIRL and SWIR₂ represent a reflectance of red edge 3 band, a reflectance of red edge 4 band, a reflectance of blue band, a reflectance of green band, a reflectance of near infrared band, a reflectance of short wave infrared 1 band, and a reflectance of short wave infrared 2 band in the Sentinel-satellite images, respectively. NDMI and AWEIsh represent a normalized difference mud index and an automatic water extraction index, respectively.

In step 504, the MWI gray images are converted into binary images by using a maximum inter-class variance method, and the binary images include pixels representing a water portion and a land portion.

The binary images, converted from the mixed water index gray images by using the maximum inter-class variance method, are water/land binary images, and a value of the water portion is 1 and a value of the land portion is 0.

In step 506, the water portion in the binary images is vectorized to obtain the training region boundary.

The water portion in the binary images may be vectorized in a geographic information system software such as a Quantum Geographic Information System (QGIS). Meanwhile, a visual adjustment may be performed by combining the sample optical images corresponding to the binary images to obtain a high-accuracy water surface range as the training region boundary. The training region boundary obtained may be inputted into the GEE cloud computing platform.

According to the embodiment of the present application, the training region boundary is obtained by converting the sample optical images into the binary images to facilitate the establishment of the classification algorithm in subsequent steps. The sample optical images are acquired from the Sentinel-2, and a spatial resolution of the corresponding band of the Sentinel-2 is 10 m to 20 m, therefore the spatial resolution of the training region boundary obtained in the embodiment of the present application is relatively high, thus improving the accuracy of the classification algorithm, and inversing a more accurate water area.

In an embodiment, as shown in FIG. 6, the step 202 of classifying the SAR image sequence by the classification algorithm, and determining the water pixels in the SAR image sequence according to the classification result may include the following steps 602 to 606.

In step 602, a feature vector of each of the pixels in the SAR images is obtained according to the SAR image sequence, and the feature vector includes the VV backscattering coefficient, the VH backscattering coefficient, the VV backscattering coefficient processed by the moving average, the vertical-horizontal backscattering coefficient processed by the moving average, the elevation value, and the slope value.

Each of the SAR images in the SAR image sequence is pre-processed by a moving average and the NASADEM to obtain the VV backscattering coefficient, the VH backscattering coefficient, the VV backscattering coefficient processed by the moving average, the VH backscattering coefficient processed by the moving average, and the elevation value and the slope value derived by the NASADEM for each of the pixels in each SAR image.

In step 604, the feature vector of each of the pixels is inputted into the classification algorithm to obtain a classification result for each of the pixels.

Where, the feature vector including the VV backscattering coefficient, the VH backscattering coefficient, the VV backscattering coefficient processed by the moving average, the VH backscattering coefficient processed by the moving average, and the elevation value and the slope value derived by the NASADEM may be used as an independent variable of one pixel and is inputted into the classification algorithm. The classification result outputted by the classification algorithm may characterize whether the pixel is water. If the pixel is water, the outputted classification result is 0, otherwise, the outputted classification result is 1.

In step 606, the water pixels in the SAR image sequence are determined according to the classification results.

After the classification result of each of the pixels is obtained, the number of pixels being water i.e., the number of water pixels, in each of the SAR images is determined according to the classification results.

In an embodiment of the present application, the classification for the SAR image sequence is realized by using the feature vector as an input of the classification algorithm, where the feature vector includes six parameters, namely the vertical-vertical backscattering coefficient, the vertical-horizontal backscattering coefficient, the vertical-vertical backscattering coefficient processed by the moving average, the vertical-horizontal backscattering coefficient processed by the moving average, the elevation value, and the slope value, thereby improving accuracy of the classification result.

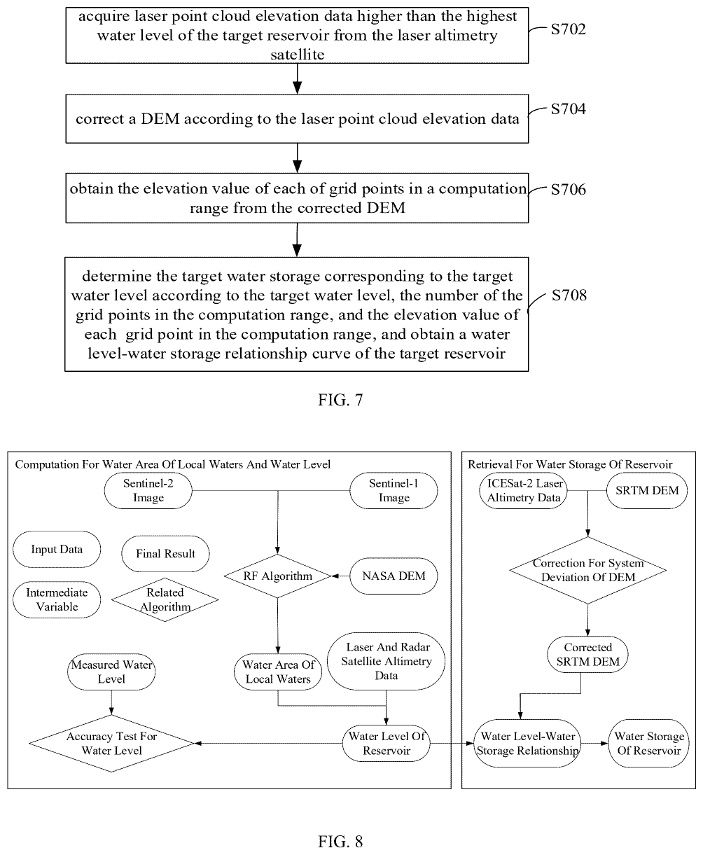

In an embodiment, as shown in FIG. 7, before the step 110 of obtaining the water storage sequence of the target reservoir according to the water level-water storage relationship curve and the target water level sequence, the method may include the following steps 702 to 708.

In step 702, laser point cloud elevation data higher than the highest water level of the target reservoir are acquired from the laser altimetry satellite.

In an embodiment of the present application, not only the input of the water level but also the water level-water storage relationship curve of the target reservoir is required in the retrieval computation process of the water storage. The water level-water storage relationship curve needs to be computed by the DEM. A conventional DEM is a Shuttle Radar Terrain Mission (SRTM) DEM. Before the water level-water storage relationship of the target reservoir is computed, a systematic deviation of the DEM data needs to be corrected by using data from the laser altimetry satellite.

Exemplarily, firstly, the laser point cloud elevation data for land surface and the water surface, which are within a 1000-meter-wide buffer zone of the target reservoir boundary (namely, a zone extending outwards from the target reservoir boundary for 1000 meters), may be obtained by using ICESat-2 ATL03 along-track photon heights, the ATL 08 along-track land surface and canopy heights, and a Photon Research and Engineering Analysis Library (PhoREAL) software. The precision of the laser point cloud elevation data is higher than that of the SRTM DEM data. Due to a large number of laser photons emitted by the laser satellites, these photons intersect with the ground or the water surface at many intersection points, which constitute a point cloud in the three-dimensional space. Each of the intersection points has a corresponding elevation, i.e., one of the laser point cloud elevation data. And the laser point cloud elevation data higher than the highest water level of the target reservoir are extracted from the laser point cloud elevation data of the land surface and the water surface.

In step 704, the DEM is corrected according to the laser point cloud elevation data.

Each of the laser points is located at a spatial location with a corresponding SRTM DEM elevation, the elevation data may differ from the laser point cloud elevation data measured by the ICESat-2, where the elevation data measured by the ICESat-2 are more accurate. The extracted laser point cloud elevation data may be compared with the elevation data corresponding to the SRTM DEM to obtain elevation differences. Around the target reservoir, there is a mean value of the elevation differences, and a systematic error of the SRTM DEM may be eliminated by subtracting the mean value from each data point of the SRTM DEM.

In step 706, the elevation value of each grid point in a computation range is obtained from the corrected DEM, and the computation range is obtained according to the maximum water surface range of the target reservoir.

The SRTM DEM data are 30 m×30 m grid data, and each grid point (i.e., pixel) has an elevation value (which may be understood as an altitude value, a distance from the land surface to a referenced level surface), and therefore the SRTM DEM characterizes the terrain around the target reservoir. The computation range may be the maximum water surface range of the target reservoir plus the buffer zone (e.g., 200 m), thereby ensuring that no grid points are missed. The maximum water surface range of the target reservoir may be obtained from the open data set JRC GSW or GRanD.

In step 708, the target water storage corresponding to the target water level is determined according to the target water level, the number of grid points in the computation range, and the elevation value of each grid point in the computation range, and the water level-water storage relationship curve of the target reservoir is obtained.

Where, the target water level is a selected water level to be computed, and the target water storage is the water storage of the target reservoir when the target reservoir has the target water level.

Exemplarily, the SRTM DEMs were acquired in February 2000, therefore, the water level-water storage relationship of the reservoir may be directly computed for the reservoir in which water was stored after February 2000. The computation method for the water level-water storage relationship curve is as Equation (4).

S(H)=Σᵢ₌₁^{N}max{H−hᵢ,0}×30×30 (4)

Where, H represents the target water level, S(H) represents the target water storage corresponding to the target water level, hᵢ represents the SRTM DEM elevation value of an i-th grid point, and N represents the number of SRTM DEM grid points within the computation range.

For reservoirs in which water was stored before February 2000, the water level-water area relationship of the water surface may be computed based on the SRTM DEM, and the computation method is as Equation (5).

$$A ( H ) = {\sum }_{i = 1}^{N} max \{ sgn ( H - {h}_{i} ) , 0 \} \times 30 \times 30 \qquad ( 5 )$$

Where, H represents the target water level, A(H) represents the water area corresponding to the target water level, hᵢ represents the SRTM DEM elevation value of the i-th grid point, N represents the number of the SRTM DEM grid points within the computation range, and a sgn function is a symbolic function, and defined as Equation (6).

$$sgn ( x ) = \{ \begin{matrix}1 , & if x > 0 \\ 0 , & if x \leq 0\end{matrix} \qquad ( 6 )$$

After the water level-water area relationship above the is obtained, A(H) is polynomially fitted and extended below the water level, and the water level-water storage relationship of the target reservoir is obtained by integrating the water level-water area relationship as Equation (7).

S(H)=∫ₕ_{₀}^{H}A(h)dh (7)

Where, h₀ satisfies A(h₀)=0, and S(H) represents the target water storage corresponding to the target water level.

In the embodiment of the present application, the DEM is corrected by the laser altimetry satellite, and the elevation value of each grid point in the computation range is obtained from the corrected DEM, and the water level-water storage relationship curve of the target reservoir is obtained to obtain the water level-water storage relationship curve with high accuracy, thereby improving the accuracy of the retrieval result of the water storage of the target reservoir.

It should be understood that although the various steps in the flowcharts involved in various aforementioned embodiments are displayed in sequence as indicated by the arrows, these steps are not necessarily performed in sequence in the order indicated by the arrows. Unless expressly stated herein, the execution of these steps is not strictly restrictive and may be performed in other orders. Moreover, at least part of the steps in the flowcharts involved in various embodiments above may include a plurality of steps or a plurality of stages, which are not necessarily performed at the same moment, but may be executed at different moments, and these steps or stages are not necessarily performed sequentially, but may be performed in turn or alternately with other steps or at least part of the steps or stages of other steps.

To facilitate further understanding of the retrieval method for the reservoir water storage in the present application, referring to FIG. 8, a flow chart of the remote sensing retrieval algorithm for reservoir water storage is provided herein. A local water surface of a target reservoir is selected as a study area, preferably, for a narrow and long reservoir, a river section with a wide water surface is selected. Then optical image pairs are selected, where each optical image pair is selected from optical images of the Sentinel-2 and SAR images from the Sentinel-1 within close time (usually within a time interval of five days) respectively, that is a time difference between time points, when the sample optical image and the sample SAR image in each of the plurality of sample image pairs are captured respectively, is less than five days, so that the areas of the water surfaces of the optical image pair are similar. The images from the Sentinel-2, which have good imaging quality and fewer clouds, are retained according to a ratio of effective observation pixels. In addition, the training samples should cover the time period when the reservoir has a maximum water storage and a minimum water storage as far as possible, to ensure that a final water level sequence and a water storage sequence may capture a peak value and a valley value. The water areas of the local waters of the optical images are extracted as references by using the MWIs and the maximum inter-class variance method, and based on the DEM, the backscattering coefficient of the VV polarization, and the backscattering coefficient of the VH polarization in the SAR images, the RF classifier is trained to obtain the RF algorithm. The water area sequence is extracted by using the classification algorithm and the SAR images. The water level-water area relationship of the local waters of the reservoir is constructed by combining the water area sequence with the water level of the reservoir retrieved by the radar altimetry satellite and the laser altimetry satellite, thus converting the water area sequence into the target water level sequence. The DEM is corrected by using the laser altimetry satellite data, and the water level-water storage relationship of the reservoir is computed based on the corrected DEM, and the water storage time sequence of the target reservoir is computed by combining the target water level sequence.

The embodiment of the present application addresses the problem of low temporal resolution and low accuracy of the remote sensing retrieval result of the reservoir water storage change by the satellite, and provides the retrieval method for the reservoir water storage combining the optical images, the SAR remote sensing images, and the laser radar satellite altimetry data. The retrieval method may effectively use the SAR images to extract the water area of the local waters of the reservoir. The embodiment of the present invention, compared with the conventional retrieval method based on the whole reservoir water area, reduces the computation errors of the water storage and the computation resource consumption, and significantly improves the spatiotemporal resolutions and the accuracy of the retrieval result of the reservoir water storage.

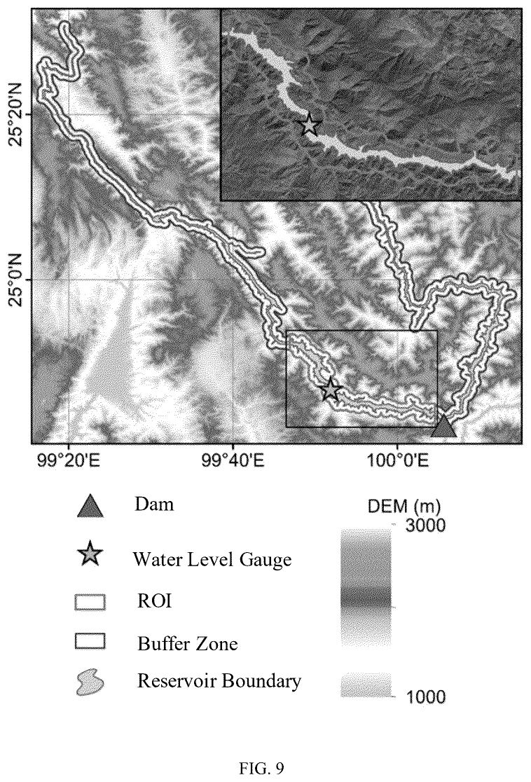

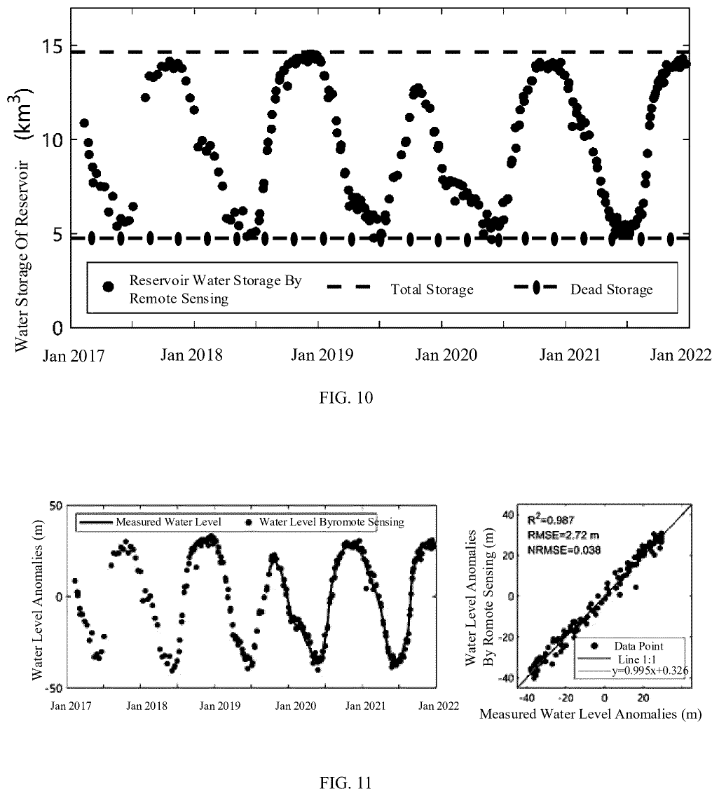

The accuracy of the water level may be tested by comparing the retrieved water level with the in-situ measured water level of the reservoir. The Xiaowan reservoir is taken as an example. The Xiaowan reservoir, located at 100 degrees east longitude and 25 degrees north latitude, is the second largest reservoir in the branch reservoirs in the main stem of the Lancang River, and has a total storage of 14.65 km³ and a dead storage of 4.75 km³. The Xiaowan reservoir is regulated annually, in the manner of storing water from June to November of a year and discharging from December of the year to May of the following year. Both the Sentinel-1/2 satellite and the ICESat-2 satellite pass through the Xiaowan reservoir, and provide a data basis for the retrieval for the water storage. The measured data used for testing are data from water level gauges installed in the reservoir, which include daily accurate reservoir water level anomalies since September 2019, and the terrain of the Xiaowan reservoir terrain and the selection of the region of interest (ROI) are shown in FIG. 9. In the present application, the retrieval results of the water storage of the Xiaowan reservoir obtained by the retrieval method for the reservoir water storage are shown in FIGS. 10 and 11. By comparing the measured water level with the retrieved water level change by the remote sensing retrieval, it is obtained that a root mean square error is 2.72 m (a corresponding water storage error is about 0.38 km³), R² is about 0.973, and a slope of a fitted line is 0.995, and it is proved that there is no systematic deviation approximately in the remote sensing retrieval results. It can be seen from FIGS. 10 and 11 that, except for retrieval results of few dates, the remote sensing retrieval results are very accurate in capturing changes in reservoir water storages, and have a great application value.

Therefore, the retrieval method for the reservoir water storage based on the optical remote sensing images, radar remote sensing images and satellite altimetry provided by the present application, achieves the monitoring of the reservoir water storage under complex terrain conditions, and may serve for reservoir scheduling and river management, and so on, and provides a technical basis for hydrological simulation of a river basin lacking for data in the case of a runoff regulation by reservoir. The implementation of the embodiments of the present application is based on optical images from the Sentinel-2 satellite, SAR images from the Sentinel-1 satellite, the data from the ICESat-2 altimetry satellite and the Jason-3 altimetry satellite. The classification algorithm for the waters of the SAR images is trained by taking the water area of the local waters in the cloud-free optical images as references, and the local water surface area information with a weekly-scale resolution is extracted, the water level-water storage relationship of the reservoir is established by combining the water level data retrieved from the satellite altimetry data and the digital elevation model, and the reservoir water storage with the weekly-scale temporal resolution is computed. Compared with a conventional retrieval algorithm for water storage based on optical images or the altimetry satellite data, the retrieval result of the reservoir water storage in the embodiment of the present application has a higher temporal resolution and a higher retrieval accuracy. The test result based on the measured water level of the Xiaowan reservoir shows that the root mean square error of the remote sensing retrieval of the water level is 2.72 m, and that the goodness of fit R² is 0.987. The embodiments of the present application are applicable to various reservoirs. However, due to the penetrability and noise of the SAR images, there is some uncertainty when the embodiments of the present application are applied to a reservoir having a small change in water level or in water area. The temporal resolution of the retrieval result of the water storage is determined by the revisiting period of the Sentinel-1. Since the Sentinel-1 consists of two identical satellites, the Sentinel-1 has an irregular revisiting period, which is about 7 days.

The retrieval method for the reservoir water storage provided by the embodiments of the present application mainly relates to optical remote sensing, radar remote sensing, altimetry technology, geographic information system and hydrological water resources, and can realize the monitoring for the reservoir water storage at a low cost, in a large range and with a high efficiency. On the basis of knowing a change rule of the water level of the reservoir and the reservoir water storage, the reservoir water storage is retrieved by using the water classification results of the optical images and the SAR images, and by combining the retrieval results of the water level from the radar altimetry satellite and the laser altimetry satellite with the water level-water storage relationship of the reservoir. Through a joint innovation of satellite remote sensing, geodetic survey, hydrology and other disciplines, reliable estimated water storage of a reservoir is provided to serve for the reservoir monitoring and scheduling, basin hydrological simulation, water resource management and the like, which effectively reduces the cost of in-situ monitoring for the reservoir. According to the embodiments of the present application, an effect of the ideal retrieval result of the reservoir water storage can be achieved by using multi-source satellite data. With the update of earth observation satellites, such as the SWOT satellite to be launched in 2022, the practicality and reliability of the present application are expected to be further improved, therefore the present application has a great potential in application.

Based on the same inventive concept, an embodiment of the present application further provides an retrieval apparatus for the reservoir water storage, configured to implement the above retrieval method for the reservoir water storage. The solution provided by the apparatus for solving the problem is similar to the solution described in the above method. Therefore, for specific limitations in one or more embodiments of the retrieval apparatus for the reservoir water storage provided below, a reference can be made to the above limitations of the retrieval method for the reservoir water storage, which will not be described herein.

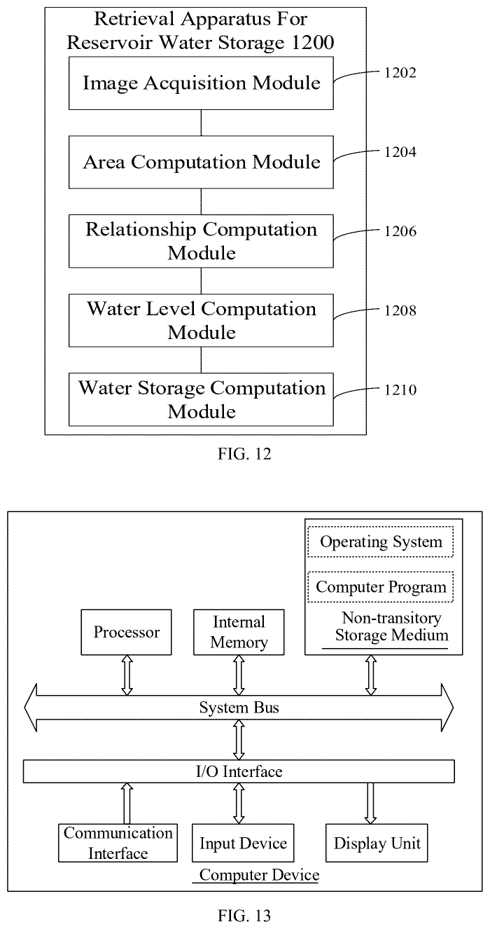

In an embodiment, referring to FIG. 12, the retrieval apparatus for the reservoir water storage 1200 is provided. The retrieval apparatus for the reservoir water storage 1200 includes an image acquisition module 1202, an area computation module 1204, a relationship computation module 1206, a water level computation module 1208, and a water storage computation module 1210.

The image acquisition module 1202 is configured to acquire a synthetic aperture radar (SAR) image sequence covering target local waters of a target reservoir.

The area computation module 1204 is configured to determine a water area sequence of the target local waters according to the SAR image sequence.

The relationship computation module 1206 is configured to obtain a first relationship between a water level of the target reservoir and the water area of the target local waters of the target reservoir.

The water level computation module 1208 is configured to convert the water area sequence into a target water level sequence according to the first relationship.

The water storage computation module 1210 is configured to obtain the water storage sequence of the target reservoir according to the water level-water storage relationship curve and the target water level sequence.

In the retrieval apparatus for the reservoir water storage provided by the present application, the image acquisition module 1202 acquires the SAR image sequence of the target local waters in the target reservoir, the area computation module 1204 determines the water area sequence of the target local waters according to the SAR image sequence, the relationship computation module 1206 obtains a first relationship between the water level of the target reservoir and the water area of the target local waters of the target reservoir, the water level computation module 1208 converts the water area sequence into a target water level sequence according to the first relationship, and the water storage computation module 1210 obtains the water storage sequence of the target reservoir according to the water level-water storage relationship curve and the target water level sequence. Compared with the method of extracting the whole reservoir area in the related art, the method in the present application includes obtaining the water area sequence of the target local waters, and the amount of data is comparatively small, thus reducing computational load, simplifying the computation, and reducing computational resource consumption and computation errors. In addition, since the SAR images are acquired from the Sentinel-1 satellite, and have a comparatively high temporal resolution, thus the temporal resolution of the target water level sequence of the present application finally obtained by converting is high, thereby improving the accuracy of the retrieval result of the water storage.

In an embodiment, the area computation module 1204 is further configured to classify the SAR image sequence by a classification algorithm, and determine water pixels in the SAR image sequence according to a classification result, where the water pixels are pixels of a water classification, and configured to determine the water area sequence of the target local waters according to each of the water pixels in the SAR image sequence.

In an embodiment, the relationship computation module 1206 is further configured to acquire an initial water level sequence of the target reservoir according to the laser altimetry satellite and/or the radar altimetry satellite, configured to obtain an initial partial water area sequence corresponding to the initial water level sequence from the water area sequence according to time information corresponding to the initial water level sequence, and configured to process the initial water level sequence of the target reservoir and the initial partial water area sequence of the target reservoir by a polynomial regression to obtain the first relationship between the water level and the water area of the target local waters of the target reservoir.

In an embodiment, the retrieval apparatus for the reservoir water storage 1200 further includes an algorithm training module configured to acquire a plurality of sample image pairs of the target local waters, each of which includes a sample optical image and a sample SAR image, configured to determine a training region boundary according to the sample optical image, which is a boundary between water and land in the target local waters, configured to obtain sample features according to the sample SAR images, which include a vertical-vertical (VV) backscattering coefficient, a vertical-horizontal (VH) backscattering coefficient, a vertical-vertical (VV) backscattering coefficient processed by a moving average, a vertical-horizontal (VH) backscattering coefficient processed by a moving average, an elevation value and a slope value, and configured to select, according to the training region boundary, training samples from the sample SAR images, and input the sample features of the training samples into a random forest classifier for training to obtain the classification algorithm.

In an embodiment, the algorithm training module is further configured to determine MWI gray images of the sample optical images, configured to convert, by using a maximum inter-class variance method, the MWI gray images into binary images, which include pixels representing a water portion and a land portion, and configured to vectorize the water portion in the binary images to obtain the training region boundary.

In an embodiment, the area computation module 1204 is further configured to obtain a feature vector of each of the pixels in the SAR images according to the SAR image sequence, which includes the VV backscattering coefficient, the VH backscattering coefficient, the VV backscattering coefficient processed by the moving average, the VV backscattering coefficient processed by the moving average, the elevation value and the slope value, configured to input the feature vector of each of the pixels into the classification algorithm to obtain a classification result for each of the pixels, and configured to determine the water pixels in the SAR image sequence according to the classification results.

In an embodiment, the retrieval apparatus for the reservoir water storage further includes a curve acquisition module configured to acquire laser point cloud elevation data higher than the highest water level of the target reservoir from the laser altimetry satellite, configured to correct the digital elevation model (DEM) according to the laser point cloud elevation data, configured to obtain, from the corrected DEM, the elevation value of each grid point in a computation range obtained according to a maximum water surface range of the target reservoir, and configured to determine the target water storage corresponding to the target water level according to the target water level, the number of grid points in the computation range, and the elevation value of each grid point in the computation range, and configured to obtain the water level-water storage relationship curve of the target reservoir.

Each module in the above retrieval apparatus for the reservoir water storage may be implemented in whole or in part by software, hardware, and combinations thereof. The modules may be embedded in or independent of the processor of the computer device in a form of hardware, or may be stored in the memory of the computer device in a form of software, to facilitate the processor calling and executing the operations corresponding to each of the above modules.

In an embodiment, a computer device is provided. The computer device may be a server, and an internal configuration structure of the computer device may be shown in FIG. 13. The computer device includes a processor, a memory, and a communication interface, which are connected by system buses. The processor of the computer device is configured to provide computing and control capabilities. The memory of the computer device includes a non-transitory storage medium and an internal memory. The non-transitory storage medium stores an operating system, a computer program, and a database. The internal memory provides an environment for the operation of the operating system and the computer program in the non-transitory storage medium. The network interface of the computer device is configured for communication with an external terminal. The computer program is executed by the processor to implement the retrieval method for the reservoir water storage.

It should be understood by those of ordinary skill in the art that the structure shown in FIG. 13 is a block diagram illustrating only part of the structure associated with the solutions of the present disclosure, but not intended to limit the computer device to which the solutions of the present disclosure are applied, and that the specific computer device may include more or less components than those shown in the figure, or may combine with certain components, or may have a different arrangement of components.

In an embodiment, a computer device including a memory and a processor is provided. The memory has a computer program stored therein. The processor, when executing the computer program, implements the steps in the above method embodiments.

In an embodiment, a non-transitory computer-readable storage medium is provided. A computer program is stored on the non-transitory computer-readable storage medium, and the computer program, when executed by a processor, causes the processor to implement the steps in the above method embodiments.

It should be noted that the user information (including but not limited to user device information, user personal information, and the like) and data (including but not limited to data for analysis, stored data, displayed data, and the like) involved in the present application are information and data authorized by the user or fully authorized by all parties.

Those ordinary skilled in the art may understand that all or part of the process in the method of the above-mentioned embodiments may be implemented by instructing the relevant hardware through a computer program, and the computer program may be stored in a non-volatile readable storage medium of the computer, when executed, the computer program may include the processes of the embodiments of the methods above. Wherein, any reference to memory, storage, database, or other media used in the various embodiments provided in this application may include at least one of non-volatile and volatile memory. Non-volatile memory may include read-only memory (Read-Only Memory, ROM), magnetic tape, floppy disk, flash memory, or optical memory, high-density embedded non-transitory memory, resistance random access memory (ReRAM), magneto resistive random-access memory (MRAM), ferroelectric random-access memory (FRAM), phase change memory (PCM), graphene memory, and the like. Volatile memory may include random access memory (RAM) or external cache memory. By way of illustration and not limitation, the RAM may be in various forms, such as static random-access memory (SRAM) or dynamic random-access memory (DRAM), etc. The databases involved in the embodiments provided in the present application may include at least one of a relational database and a non-relational database. The non-relational databases may include, but are not limited to, a blockchain-based distributed database, and the like. The processors involved in the embodiments provided in the present application may be, but are not limited to, a general-purpose processor, a central processing unit, a graphics processor, a digital signal processor, a programmable logic, a quantum-computing-based data processing logic, and the like.

The technical features involved in the embodiments above may be combined arbitrarily. For the sake of concision of the description, not all possible combinations of the technical features of the embodiments are described. However, as long as there is no contradiction in the combinations of these technical features, the combinations should be considered to be within the scope of the description.

The above embodiments are only several implementations of the present application, but should not be construed as limiting the scope of the disclosure. It should be noted that for those of ordinary skill in the art, variations and improvements may be made without departing from the concept of the disclosure, and these variations and improvements all fall within the scope of protection of the disclosure. Therefore, the scope of protection of the present application shall be subject to the attached claims.

What is claimed is:

1. A retrieval method for reservoir water storage, comprising:
acquiring a synthetic aperture radar (SAR) image sequence covering target local waters of a target reservoir;
determining a water area sequence of the target local waters of the target reservoir by using a classification algorithm on a cloud computing platform according to the SAR image sequence, the classification algorithm comprising a random forest (RF) algorithm;
acquiring an initial water level sequence of the target reservoir according to at least one of a laser altimetry satellite and a radar altimetry satellite;
obtaining an initial partial water area sequence, corresponding to the initial water level sequence, from the water area sequence according to time information corresponding to the initial water level sequence;
obtaining a first relationship between a water level of the target reservoir and a water area of the target local waters of the target reservoir based on the initial water level sequence of the target reservoir and the initial partial water area sequence of the target reservoir;
converting the water area sequence into a target water level sequence according to the first relationship; and
obtaining a water storage sequence of the target reservoir according to a water level-water storage relationship curve and the target water level sequence.

2. The retrieval method for the reservoir water storage according to claim 1, wherein the determining the water area sequence of the target local waters by using the classification algorithm on the cloud computing platform according to the SAR image sequence comprises:
classifying the SAR image sequence by the classification algorithm on the cloud computing platform, and determining water pixels in the SAR image sequence according to a classification result, the water pixels being pixels of a water classification; and
determining the water area sequence of the target local waters according to each of the water pixels in the SAR image sequence.

3. The retrieval method for the reservoir water storage according to claim 1, wherein the obtaining the first relationship between the water level of the target reservoir and the water area of the target local waters of the target reservoir based on the initial water level sequence of the target reservoir and the initial partial water area sequence of the target reservoir, comprises:
processing the initial water level sequence of the target reservoir and the initial partial water area sequence of the target reservoir by a polynomial regression to obtain the first relationship between the water level of the target reservoir and the water area of the target local waters of the target reservoir.

4. The retrieval method for the reservoir water storage according to claim 2, further comprising:
acquiring a plurality of sample image pairs of the target local waters, each of the plurality of the sample image pairs comprising a sample optical image and a sample SAR image;
determining a training region boundary according to the sample optical image, and the training region boundary being a boundary between water and land in the target local waters;
obtaining sample features according to the sample SAR images, and the sample features comprising a vertical-vertical (VV) backscattering coefficient, a vertical-horizontal (VH) backscattering coefficient, a VV backscattering coefficient processed by a moving average, a VH backscattering coefficient processed by the moving average, an elevation value, and a slope value; and
selecting training samples from the sample SAR images according to the training region boundary, and inputting the sample features of the training samples into a RF classifier for training to obtain the classification algorithm.

5. The retrieval method for the reservoir water storage according to claim 4, wherein the determining the training region boundary according to the sample optical image comprises:
determining mixed water index (MWI) gray images of the sample optical image;
converting the MWI gray images into binary images by using a maximum inter-class variance method, and the binary images comprising pixels representing a water portion and a land portion; and
vectorizing the water portion in the binary images to obtain the training region boundary.

6. The retrieval method for the reservoir water storage according to claim 2, wherein the classifying the SAR image sequence by the classification algorithm on the cloud computing platform, and the determining water pixels in the SAR image sequence according to the classification result, comprises:
obtaining a feature vector of each of the pixels in the SAR image according to the SAR image sequence, and the feature vector comprising a vertical-vertical (VV) backscattering coefficient, a vertical-horizontal (VH) backscattering coefficient, a VV backscattering coefficient processed by a moving average, a VH backscattering coefficient processed by the moving average, an elevation value, and a slope value;
inputting the feature vector of each of the pixels into the classification algorithm to obtain a classification result of the each of the pixels; and
determining the water pixels in the SAR image sequence according to classification results.

7. The retrieval method for the reservoir water storage according to claim 1, wherein before the obtaining the water storage sequence of the target reservoir according to the water level-water storage relationship curve and the target water level sequence, the method comprises:
acquiring laser point cloud elevation data higher than the highest water level of the target reservoir from a laser altimetry satellite;
correcting a digital elevation model (DEM) according to the laser point cloud elevation data;
obtaining the elevation value of each grid point in a computation range from the corrected DEM, and the computation range being obtained according to a maximum water surface range of the target reservoir; and
determining the target water storage corresponding to the target water level according to the target water level, the number of the grid points in the computation range, and the elevation value of each of the grid points in the computation range, and obtaining the water level-water storage relationship curve of the target reservoir.

8. The retrieval method for the reservoir water storage according to claim 4, wherein a time difference between time points, when the sample optical image and the sample SAR image in each of the plurality of sample image pairs are captured respectively, is less than five days.

9. The retrieval method for the reservoir water storage according to claim 1, wherein the target local waters refer to a region of the target reservoir with a flat terrain and wide open water surface.

10. The retrieval method for the reservoir water storage according to claim 4, wherein the selecting the training samples from the sample SAR images according to the training region boundary, comprises:
processing a buffer zone for the training region boundary by extending the training region boundary outwards by a certain distance; and
selecting the training samples according to a ratio of the number of the water pixels to the number of land pixels being 1:3.

11. The retrieval method for the reservoir water storage according to claim 4, wherein
the selecting training samples from the sample SAR images according to the training region boundary, and inputting the sample features of the training samples into the RF classifier for training to obtain the classification algorithm, comprise:
selecting 12 sets of training samples from the sample SAR images according to the training region boundary, and inputting the sample features of 11 sets of the selected training samples into the RF classifier for training to obtain the classification algorithm; and
after obtaining the classification algorithm, the retrieval method for the reservoir water storage further comprises:
testing the classification algorithm by using a remaining set of the training samples.

12. The retrieval method for the reservoir water storage according to claim 11, wherein
a training process is performed on a Google Earth Engine to obtain the classification algorithm; and
the testing the classification algorithm by using the remaining set of the training samples is performed on the Google Earth Engine.

13. A retrieval apparatus for reservoir water storage, comprising:
an image acquisition module, configured to acquire a synthetic aperture radar (SAR) image sequence covering target local waters of a target reservoir;
an area computation module, configured to determine a water area sequence of the target local waters by using a classification algorithm on a cloud computing platform according to the SAR image sequence, the classification algorithm comprising a random forest (RF) algorithm;
a relationship computation module, configured to acquire an initial water level sequence of the target reservoir according to at least one of a laser altimetry satellite and a radar altimetry satellite, obtain an initial partial water area sequence, corresponding to the initial water level sequence, from the water area sequence according to time information corresponding to the initial water level sequence, and obtain a first relationship between a water level of the target reservoir and a water area of the target local waters of the target reservoir based on the initial water level sequence of the target reservoir and the initial partial water area sequence of the target reservoir;
a water level computation module, configured to convert the water area sequence into a target water level sequence according to the first relationship; and
a water storage computation module, configured to obtain a water storage sequence of the target reservoir according to a water level-water storage relationship curve and the target water level sequence.

14. A computer device, comprising a memory and a processor, the memory having a computer program stored thereon, wherein, the processor, when executing the computer program, performs steps of the method according to claim 1.

15. A non-transitory computer-readable storage medium, having a computer program stored thereon, wherein the computer program, when executed by a processor, causes the processor to perform steps of the method according to claim 1.
